(19) United States
(12) Patent Application Publication
(10) Pub. No.: US 2011/0276385 A1
(43) Pub. Date: Nov. 10, 2011

(54) Mobile Shopping Decision Agent

(75) Inventor: Marc B. Keller, Charlotte, NC (US)

(73) Assignee: Bank of America Corporation, Charlotte, NC (US)

(21) Appl. No.: 12/775,329

(22) Filed: May 6, 2010

(51) Int. Cl. G06Q 30/00; H04L 12/26

(52) U.S. Cl. 705/14.38; 705/346; 705/21; 370/241

(57) ABSTRACT

A mobile shopping decision agent application is disclosed. A wireless-enabled (e.g., WiFi) device that uses three or more routers to locate the exact position (e.g., aisle number, shelf, etc. in a store) of a user operating the wireless-enabled device to provide the user with assistance in shopping (e.g., comparison, order online, read technical specifications, read customer reviews, etc.) for a product, and allows the user to purchase the product on the spot from the merchant (or another competing merchant) direct from his/her account with a bank online or at the merchant POS/checkout. In addition, application also may use various social networking features (e.g., product recommendations from friends, recommendations from public at large, wish list, etc.) to enhance the customer's shopping experience.

This application claims priority from U.S. Provisional Application No. 60/184,403, entitled, “MOBILE SHOPPING,” filed on Jun. 5, 2009, and which is herein incorporated by reference in its entirety.

### BACKGROUND

In a store setting, consumers may not know the exact location of particular items that they would like to purchase within the store or their current location relative to the desired items within the store. Additionally, consumers may not know whether they are obtaining the best price or whether other consumers approve of the product. Moreover, the store might be out of stock of a particular product, style, or size, etc. Also, when consumers wish to make purchases, they may have to wait in long lines before making the purchase. All of these may result in consumers abandoning purchases. Aspects of the disclosure below deal with helping consumers decide whether to ultimately make purchases. Additionally, aspects of the disclosure below deal with improving the chances that consumers will ultimately make purchases by providing the consumer with product information, cross-selling, and up-selling based on products considered by a purchaser and the consumer's purchasing history.

### BRIEF SUMMARY

The present disclosure contemplates a system and method for a mobile shopping decision agent and related systems and methods. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

Aspects of the disclosure relate to shopping and payment through a mobile device. More specifically, aspects of the disclosure relate to a wireless-enabled (e.g., WiFi) device that uses three or more routers to locate the exact position (e.g., aisle number, shelf, etc. in a store) of a user operating the wireless-enabled device to provide the user with assistance in shopping (e.g., comparison, order online, read technical specifications, read customer reviews, etc.) for a product, and allows the user to purchase the product on the spot from the merchant (or another competing merchant) direct from his/her account with a bank online or at the merchant POS/checkout. In addition, the disclosure also may use various social networking features (e.g., product recommendations from friends, recommendations from public at large, wish list, etc.) to enhance the customer's shopping experience.

The disclosure also contemplates a merchant user using the device in the store to assist in restocking shelves, collecting marketing data through use of RFID (“radio frequency identification”), SKU (“stock keeping unit”), and NFC (“near field communication”) (e.g., to reduce purchase abandonment by customers, cross-selling, and up-selling), and performing other merchant duties.

Aspects of the present disclosure combine the best of the in-store shopping experience with the value of online shopping and the advantages of electronic payments. The user benefits from the retail experience because she can touch and feel products while also receiving expertise/customer service from in-person sales associates. The user also benefits from the online shopping feature because she can shop for the best price, exclusive/non-exclusive discounts, and take advantage of post-sale community experience (e.g., opinions and ratings provided by friends and/or the public at large.) Moreover, the benefits of electronic payments include, but are not limited to, e-receipts (i.e., electronic copy of receipt) for tracking and budgeting purposes, gifting ability, convenience, and security.

On the merchant side, the merchant benefits from reduced purchase abandonments because nuisance issue may be eliminated/ameliorated. In addition, the merchant can cross-sell and up-sell products to the user based on the user's product inquires and purchasing history.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in accordance with aspects of the invention;

FIG. 2 shows an example of various features of aspects of the invention implemented in a retail store environment; and

FIG. 3 is a systems-level diagram of one example in accordance with various aspects of the invention.

### DETAILED DESCRIPTION

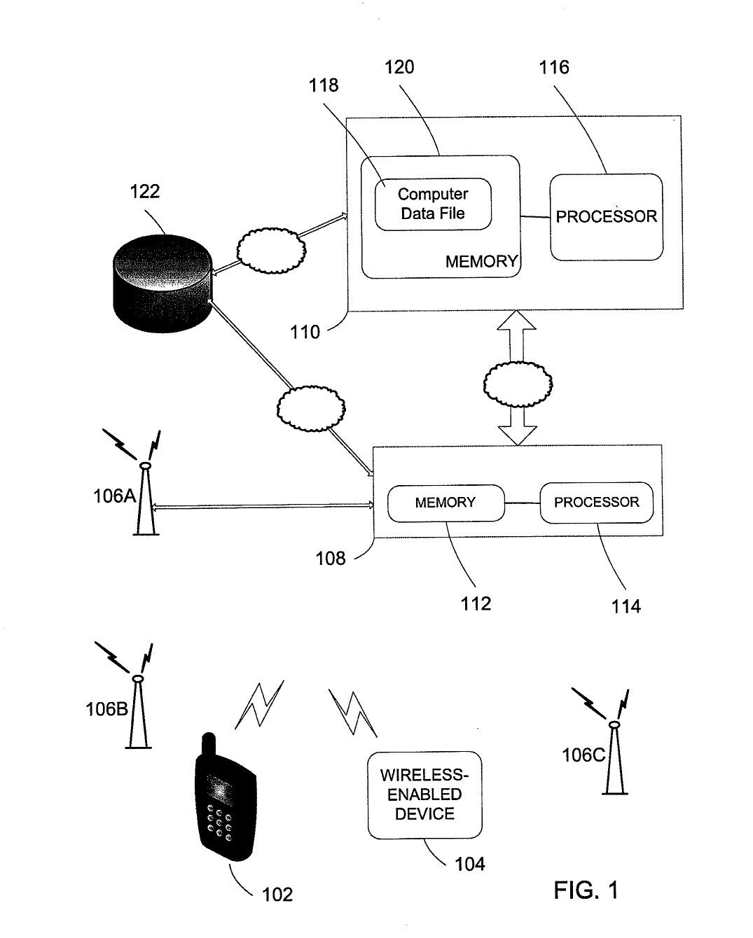

FIG. 1 depicts an illustrative operating environment in accordance with aspects of the invention. A user of wireless-enabled (e.g., 802.11a/b/g or other wireless protocols) devices 102, 104 may communicate with a wireless router 106A, 106B, 106C. The data communicated from the user devices 102, 104 may be transmitted to a server 108. The server 108 may include a memory 112 storing computer-readable instructions and a processor 114 for executing the computer-readable instructions. In some embodiments, the server 108 may be located at a retail store location, or alternatively, at a remote location from the store. The data communicated to the server 108 from the user device 102, 104 may be transmitted through a wireless router 106A, 106B, 106C and include information about the location of the user device 102, 104.

Meanwhile, another server 110 may be comprised of a memory 120 storing computer-readable instructions and a processor 116 for executing the computer-readable instructions in accordance with aspects of the invention. The memory 120 may also store computer data files 118 that stores information that may be useful to applications running on the user's mobile device 102, 104 or server 108. For example, the computer data files 118 may include store-specific data, such as, but not limited to, information about the layout of a retail store (e.g., aisle and product locations), product information (e.g., pricing), and other information. The data files 118 may also include third-party specific information, such as, but not limited to, social networking information (e.g., product reviews by friends, wish lists, etc.) The data files 118 may also include financial institution specific information, such as, but not limited to, transaction history of a customer, account balances of a customer, budgetary goals of a customer, etc. One skilled in the art will appreciate that although FIG. 1 depicts data file 118 as being stored in memory 120 in server 110, the data file 118 may be distributed over various memories, including, but not limited to, other memories in server 110 (besides memory 120), data store 122, memory 112 in server 108, etc. The data collected and stored in data file 118 may be used to support one or more of the numerous features disclosed throughout this disclosure, including appendix attached hereto.

One skilled in the art will appreciate that the server (e.g., servers 110 and 108) is not limited to a single machine or device. The server may be embodied as a web server or Internet-accessible server. Furthermore, the term server refers to any system of computers and/or devices (e.g., firewalls, routers, caching systems, proxy servers, etc. or combination thereof) that may be used to provide access to services and features available for use. As such, different reference to the server performing particular steps does not require that the same machine/device perform all the steps.

Servers 108, data store 122, server 110, and wireless access points 106A, 106B, 106C may communicate over a wired and/or wireless connection. In some instances, a private, secure connection may be established between one or more of these components. For example, server 108 and server 110 may communicate over the Internet network cloud. Alternatively, server 108 and data store 122 may communicate over a secure WAN or a dedicated T1 (or other telecommunications) line. Furthermore, wireless devices 102, 104 may include a processor, memory, display screen (e.g., touchscreen), keypad, and other electronic components conventionally found in mobile phones, PDAs, and mini-laptops.

### Store Mapping

A merchant (e.g. department store) can be mapped to the server such that the server can provide directions to a user in search of a particular product. The merchant can physically map the various locations of types of products (e.g. televisions, computers, DVDs, phones, or video games) and load this information onto the server. Once the user's device is pinpointed within the store by the routers, the server can track the user's device relative to the types of products and deliver product location information to the user's device, based on any one of a search inputted by the user, the user's purchasing history, or the user's location within the store. The product location information can be in the form of a graphical map, textual directions, or any combination thereof, etc. As the user moves throughout the store, the server can send updated product location information to the user's device automatically or upon actuation of a refresh key or other user input.

Alternatively, or in conjunction with the above method of mapping, the mapping can be accomplished by utilizing anyone of the following product identification methods alone or in combination: RFID, SKU, and NFC. With this information, the locations of individual products can be tracked by the routers within the store. For example, the RFID located on the products can be transmitted to the wireless routers to provide a particular product location within the store. Likewise NFC chips on the products can wirelessly transmit location information to the server. Additionally, SKUs can be transmitted to the wireless routers through an intermediary device such as a handheld scanner to provide location information of the products.

Through the use of this identification information, products can be tracked within the store and mapped accordingly. For example, if products are moved from one location to another location within the store, if certain products are phased out, or if new products are brought into the store for sale, the server in conjunction with the routers can update inventories, track and locate products, and then load this information onto the server's map. With this location information, in a similar fashion discussed above, the server can provide the location and inventory information to user devices upon request or based on purchasing history.

### The Shop, Purchase, and Carry Out Scenario

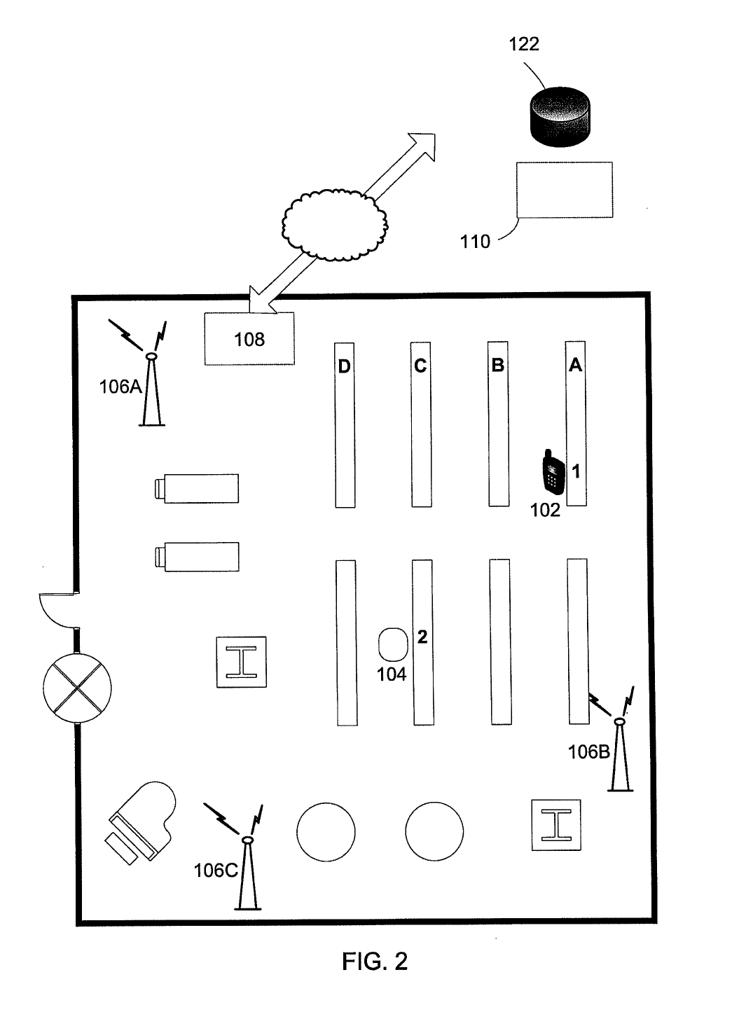

In accordance with various aspects of the disclosure, a customer enters a department store in search of a coffee maker. At the store's entrance, the customer is advised on his mobile device (e.g., 102, 104) that he is approaching the store's Wi-Fi network (e.g., a closed network) and is invited to connect to the Wi-Fi network and log in (i.e., either manually or automatically) to a Mobile Shopping Decision Agent (MSDA) application. The customer instructs his mobile device (e.g., touching the screen, pressing the ‘OK’ button, etc.) to log into the MSDA application, and he proceeds to walk toward the kitchenware aisle (e.g., Aisle A in FIG. 2).

In accordance with various aspects of the disclosure, the MSDA application may operate in a computing system environment similar to the one illustrated in FIG. 1 and FIG. 2. In another example, one or more servers 108, 110 may include a processor, RAM, ROM, communications module, and/or memory storing an operating system, applications, and/or data. The server may have a processor for controlling the overall operation of the server and its associated components, including random access memory, read-only memory, communications module, and memory. Such a server may include a variety of computer readable media. Computer readable media may be any available media that may be accessed by the server and include both volatile and nonvolatile media, removable and non-removable media. By way of example, and not limitation, computer readable media may comprise a combination of computer storage media and communication media. Computer storage media include volatile and nonvolatile, removable and non-removable media implemented in any method or technology for storage of information such as computer readable instructions, object code, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the server. Communication media commonly embodies computer readable instructions, data structures, program modules or other data in, e.g., a modulated data signal such as a carrier wave or other transport mechanism, and includes any information delivery media. By way of example, and not limitation, communication media includes wired media such as a wired network or direct-wired connection, and wireless media such as acoustic, RF, infrared and other wireless media.

The aforementioned RAM may include one or more applications representing the application data stored in RAM memory while the server is on and corresponding software applications (e.g., software tasks) running on the server. The aforementioned communications module may optionally include a microphone, keypad, touch screen, and/or stylus through which a user of the server may provide input, and may also include one or more speaker for providing audio output and a video display device for providing textual, audio/visual and/or graphical output. Software may be stored within the memory and/or storage to provide instructions to the processor for enabling the server to perform various functions. For example, memory may store software used by the server, such as an operating system, application programs, and/or an associated database. Alternatively, some or all of the computer executable instructions for the server may be embodied in hardware or firmware. Moreover, a database (or data store) may provide centralized storage of data.

Such a server may operate in a networked environment supporting connections to one or more remote computing devices. The remote computing devices may be personal computing devices or servers that include many or all of the elements described above relative to the server. Remote computing devices may be a mobile device communicating over wireless carrier channel. The network connections depicted in the figures may include a local area network (LAN) and/or a wide area network (WAN), but may also include other networks. When used in a LAN networking environment, the server may be connected to the LAN through a network interface or adapter in the communications module. When used in a WAN networking environment, the server may include a modem in the communications module or other means for establishing communications over the WAN, such as the Internet. It will be appreciated that the network connections shown and described are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various commonly known web browsers can be used to display and manipulate data on web pages.

Through Wi-Fi/LBS technology, the Mobile Shopping Decision Agent application will know the exact location of a customer in the store, e.g., at regular intervals or at all times. Accordingly, the application will deliver offers (e.g., targeted offers) and display relevant product feedback and advice in the instant a customer may be making a decision to purchase a particular item.

The store may be equipped with wireless access points (e.g., wireless router 106A, 106B, and 106C) that are capable of determining the customer's exact location in the store, for example, using triangulation techniques with three or more wireless access points. In another example, one or more disclosures U.S. patent application Ser. No. 12/177,573, including but not limited to paragraphs [20]-[28], teach techniques for determining the location of a mobile device, and techniques for authenticating a mobile device. One or more of these techniques may be used in accordance with various aspects of this disclosure.

When the customer is at position 1 (see FIG. 2) in the kitchenware aisle, the MSDA application may query a database (e.g., data store 122) containing information about what product (or product types) are located near various positions within the store. The MSDA application, in cooperation with additional software located at the server(s) (e.g., 108 in FIG. 2) and/or wireless router (e.g., 106A), may actively display relevant information (e.g., product data, product reviews, etc.) on the customer's mobile device 102. In an alternative embodiment (e.g., through a setting on the MSDA application), the MSDA application may prompt the customer with relevant information only if the customer requests it, for example, by scanning a product bar code, entering a product image, obtaining the NFC, or manually entering a product name. However, one skilled in the art will appreciate that the MSDA application in the earlier embodiment may be more beneficial to the customer because it proactively displays relevant information to him without requiring tedious input (e.g., scanning of every barcode).

In an alternative embodiment, the MSDA application may provide product information based on the user's particular purchase history. The user's purchase history may be collected in a number of different ways. For example, the particular products purchased by the user may be logged onto a server via the RFID, NFC, or SKU information or the user's transactions can be logged onto a server from the user's accounts. In addition, the purchase history information may be valuable to the merchants for a number of reasons, such as targeted promotions on certain products to the user.

Additionally, the MSDA application may provide the customer with a coupon for a product in his proximity that he might not have initially contemplating purchasing; however, the coupon (and any other information—e.g., product reviews, price comparisons between products or between venders) may convince him to make the purchase.

Additionally, the MSDA application may provide the customer with potential cross-sales or up-sales. For example, the MSDA application can provide the user with information on products that are typically purchased together or provide the user with information on higher quality products.

As such, when the customer is at position 1 (see FIG. 2) where the coffee makers are displayed in the kitchenware aisle, the MSDA application may prompt the customer with information about coffee makers. The customer may focus his search by identifying (e.g., by selecting on his mobile device's screen, by scanning the bar code on the product, using NFC, or by taking a picture of the product) that he wishes to further evaluate (e.g., price comparison, side-by-side feature comparison, reviews, consumer satisfaction ratings, etc.) Meanwhile, the customer can also look at and touch the product that he wishes to purchase. In addition, the MSDA can provide the user with cross-sell items (e.g. an espresso maker, mugs, coffee filters, coffee beans, etc.) and up-sale items (e.g. combination espresso machines and coffee makers).

Once the customer is convinced that this store provides the lowest price and/or that the coffee maker is a unique fit for what we was seeking, he may purchase (e.g., by snapping a picture of the barcode, using the NFC, by entering the barcode/product numbers into the MSDA using a keypad, etc.) the selected coffee maker directly from the MSDA application and be issued an electronic receipt. Additionally, the MSDA can provide options to purchase any additional cross-sale or up-sale items presented to the user device.

The customer may choose to exit the store and pay with his mobile device at checkout (e.g., via a NFC (near-field code) contactless reader). If the purchase is completed through the MSDA application, the funds for the purchase may be directly withdrawn from the customer's bank account and deposited directly (e.g., through ACH transfer) into the store (i.e. merchant's) bank account, thus avoiding any additional transaction fees (e.g., credit card fees). Moreover, in cases where the customer's account and the merchant's account are with the same financial institution, the transaction may be executed more efficiently and expeditiously (e.g., benefiting the merchant and financial institution involved by, in some examples, avoiding or reducing certain fees, e.g., ACH fees, where appropriate). In some embodiments in accordance with aspects of the invention, payment transactions will occur over the WiFi connection established between the customer's mobile wireless-enabled device 102 and the wireless-enabled router (e.g., 106A) located in the approximate vicinity. In such a case, the payment may be authorized and processed through a server (e.g., server 108, or other server on-site at store) computer and authorization for the fund transfer transmitted to a financial institution's remote server (e.g., server 110) for confirmation. The customer can also be provided with financing options where the transaction can be funded from various accounts or provided with a financing option payment plan.

The customer may place the coffee maker and any additional items purchased in his cart and proceed to exit the store. Security personnel at the store exit may request to see the customer's electronic receipt before allowing him to exit the store with the coffee maker and any additional items. In an alternative embodiment, the customer may be required to wait in a cashier's line where his product purchase can be confirmed and any security tags can be removed from the product packaging. Moreover, the customer may be presented with the option of being provided with a printed receipt.

### The Shop, Purchase, and Delivery Scenario

In another example, the customer enters a store in search of a LCD flat panel television. The customer walks to position 2 in aisle C (in FIG. 2) to view the LCD flat panel televisions. The infrastructure installed in the store (e.g., routers 106A-C, server 108, etc.) permit the tracking of the customer's exact location in the store. The MSDA application on the customer's mobile device 104 identifies that the customer is viewing LCD flat panel televisions. The MSDA application interactively displays information about LCD televisions on the mobile device's display. The customer is able to request a sales associate in the store to answer his questions, in addition to searching for answers on his MSDA application. Before the customer is ready to make a purchase, he uses his MSDA application to check for lower prices and/or special offers at other retail locations. The customer finds that Store B, a competitor, is selling it for $100 less. Realizing that the store may lose the customer's purchase to its competitor, the store may offer to match the competitor's price (e.g., through the issuance of a $100 coupon on-the-fly for the product, a $100 mail-in rebate, etc.) on the spot. The customer proceeds to purchase the TV from the store, satisfied that he received the lowest price without having to travel to Store B to make the purchase. The customer then proceeds to purchase the TV from the store using the MSDA application. The customer arranges for the TV to be delivered to his home and installed. The customer can proceed to leave the store without waiting in line at a cashier.

In conjunction with the above scenario, the MSDA can also provide the user with the option to purchase directly from the store, from an online competitor, or from a competitor cross-sale items with the TV, for example, HDMI cables, entertainment systems, brackets for mounting the TV, gaming systems, DVD players, installation services, etc.

The “Out-of-Stock” (or “does not Carry”), Purchase, and Delivery Scenario

In yet another example, the customer enters a store to find that the product he wishes to purchase, e.g., a pair of jeans, is out-of-stock at that store location. After doing the appropriate price comparisons, etc., the customer decides to purchase the jeans through the store for delivery to his home address. The MSDA application may direct the customer to the merchant's online site to make the purchase. Alternatively, the MSDA application may interact with the particular store merchant's system (e.g., via a closed network), and the system may assist the customer in arranging for delivery of the jeans from another store location or nearby warehouse. The customer pays for the jeans using the MSDA application on his mobile device. Alternatively, if the merchant does not carry the desired item in any of its store locations, the MSDA application may arrange for purchase and delivery from a different retailer/merchant (e.g., a competing merchant). For example, if a pair of Wrangler jeans is out of stock at Store A but in stock at Store B, then the MSDA application—through store's network system—may arrange for the purchase of that pair of jeans from Store B and arrange for home delivery. In at least one embodiment, this capability ensures that the purchase is not abandoned for reasons of “out-of stock” or “does not carry.”

The Simultaneous in-Store & Online Experience Scenario

In another example, the customer enters a store and wishes to buy a laptop computer and an external mouse. As the customer is examining a particular laptop in the corner of the store, the MSDA application prompts the customer to look over product reviews of that laptop. The customer is assured of the price and quality, and purchases the laptop computer at the store. He identifies a better deal on an external mouse at a different store (i.e., Store B). The customer authorizes the purchase of the two items from two different locations, and he is issued an electronic receipt. The customer walks out of the store with the laptop computer, while the external mouse will be delivered to his residence.

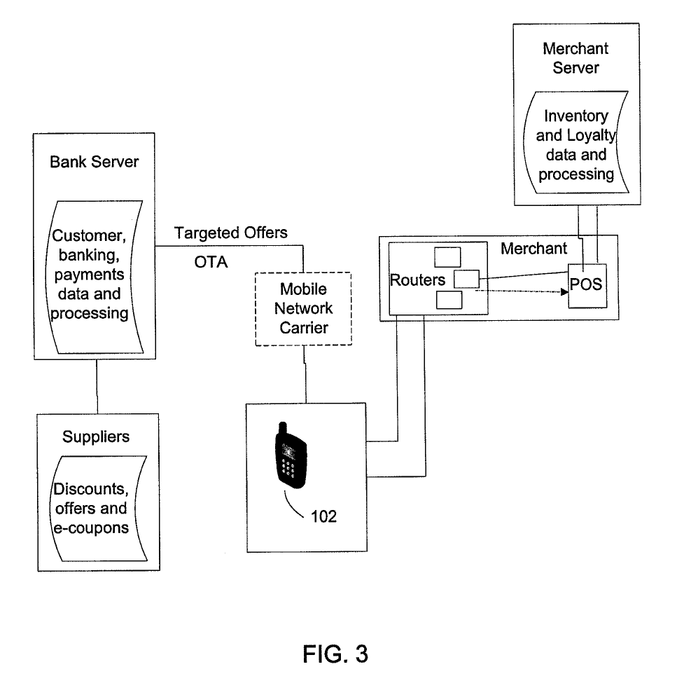

FIG. 3 is a systems-level diagram of one example in accordance with various aspects of the invention. In the box depicting a merchant store (i.e., labeled “Merchant”) the user's mobile device 102 may have two options available for purchasing an item. In one example, the purchase may be completed via NFC at the Point-of-Sale (POS) terminal In another example, the purchase may be completed via mobile banking (depicted by the dashed arrow). In an alternative embodiment, the merchant server may communicate with the user's mobile device 102 via one of many wireless protocols (e.g., 802.11a/b/g, etc.) to present targeted offers over-the-air to the user.

In addition to price comparisons and product reviews, the MSDA application may also provide other enhanced shopping assistance. For example, the MSDA application may cooperate with a customer's personal financial management software or service provider (e.g., a financial institution providing a budget setting tool to its customer, a third-party provider offering a “Can I Afford It” type of service, etc.) to evaluate whether a user should purchase an item. The customer's financial information (e.g., monthly cash flow, account balances, expenses, etc.) may be considered in recommending whether or not a user should purchase the specific item. The MSDA application may also provide a will-call feature that allows a customer to purchase/pick-up tickets for a concert/event. The MSDA application may also be used in cooperation with an Internet website (or other online software) to allow a customer in a store to shop in real time with a remote user. For example, the remote user may log into a website that allows that user to communicate (e.g., through chat or SMS) with the in-store customer.

The MSDA application may also provide numerous features to a merchant. For example, the MSDA application may assist store clerks in re-stocking shelves with products. For example, a store clerk may carry a mobile device that permits them to record where particular products are shelved (e.g., by aisle and position in the aisle). This information may be recorded in a computer data file 118 (e.g., stored in memory 112 in server 108 on-site) and later used in assisting customer's in their shopping experience. The application may also be used for out-of-stock resolution.

In addition, the MSDA application may be used to collect data that can be used for marketing purposes. For example, through the MSDA application, the merchant may be able to better design the layout of their stores, including the location of key products. The MSDA application can record the exact location of the customer and the amount of time the customer spent at each location, including other information about the customer's behavior. Moreover, the MSDA application allows the merchant to better combat issues of product abandonment by reacting to a customer's behavior in a store. For example, a customer that spends thirty minutes (or whatever predetermined amount of time) at the relatively same location in a store, then proceeds to leave the store without making a purchase may be a targeted candidate for a coupon for the particular product. Likewise, a server operated by the merchant (e.g., server 108) may generate a targeted coupon on-the-fly for related products that the merchant believes the customer may wish to purchase to further entice the customer to purchase those items at the same time. Unlike the current practice of printing coupons with the customer's receipt for presentment to the customer upon their exit of the store, this coupon on-the-fly feature permits the merchant to capture the customer's additional sale on the spot.

In accordance with aspects of the invention, a website may be provided for access to merchants and/or customers to assist in enrollment and/or installation of the MSDA application. For example, merchant may be able to enroll on the website to establish a relationship with a financial institution. As such, customers may make direct payment to the merchant through the MSDA application, thus avoiding additional fees and inefficiencies. Meanwhile, customers may register on the website for regulatory reasons, including providing an affirmative approval of the use of their information (e.g., location information) for marketing purposes. At least one benefit to customers is the opportunity to receive coupons and other promotions from merchants through the MSDA application.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. For example, a computer-readable medium storing instructions to cause a processor to perform methods in accordance with aspects of the disclosure is contemplated.

Aspects of the invention have been described in terms of illustrative embodiments thereof. Numerous other embodiments, modifications and variations within the scope and spirit of the disclosed invention will occur to persons of ordinary skill in the art from a review of this entire disclosure. For example, one of ordinary skill in the art will appreciate that the steps illustrated in the illustrative figures may be performed in other than the recited order, and that one or more steps illustrated may be optional in accordance with aspects of the disclosure.

1. A computer-implemented method comprising:
connecting a user device to a network located in a store;
wirelessly locating the user device's physical location in the store;
sending product information to the user device from a server, wherein the product information is based on a product search based on input from the user device, a purchase history, or the user device's physical location in the store.

2. The computer-implemented method of claim 1, wherein the product search is entered into the user device using a bar code scan, NFC, manual search, or an image of the product.

3. The computer-implemented method of claim 1, wherein the product information comprises one or more of the following: location information, specifications, reviews, and price.

4. The computer-implemented method of claim 3 wherein the location information comprises store mapping and the product information on price comprises a price comparison.

5. The computer-implemented method of claim 1, further comprising providing an option to purchase the product on the user device.

6. The computer-implemented method of claim 5, further comprising providing financing options for purchasing the product on the user device.

7. The computer-implemented method of claim 5, further comprising providing an option to purchase the product directly from an account stored on the user device.

8. The computer-implemented method of claim 5, wherein the server issues an electronic receipt to the user device after the product is purchased.

9. The computer-implemented method of claim 1, further comprising issuing an electronic coupon to the user device.

10. The computer-implemented method of claim 1, wherein wirelessly locating the user device's physical location in the store comprises triangulation using at least three wireless access points.

11. An apparatus comprising:
a processor for executing computer-executable instructions; and
one or more memories storing the computer-executable instructions that, when executed by the processor, cause the apparatus to perform a method comprising:
connecting a user device to a network located in a store;
wirelessly locating the user device's physical location in the store using at least three wireless routers;
sending product information to the user device, wherein the product information is based on a product search from the user device, a purchase history, or the user device's physical location in the store.

12. The apparatus of claim 11, wherein the product search is entered into the user device using a bar code scan, NFC, manual search, or an image of the product.

13. The apparatus of claim 11, wherein the product information comprises one or more of the following: location information, specifications, reviews, and price.

14. The apparatus of claim 13, wherein the location information comprises store mapping and the product information on price comprises a price comparison.

15. The apparatus of claim 11, further comprising providing an option to purchase the product directly on the user device from the store or online.

16. The apparatus of claim 15, further comprising providing financing options for purchasing the product on the user device.

17. The apparatus of claim 15, wherein the server issues an electronic receipt to the user device after the product is purchased.

18. The apparatus of claim 11, further comprising issuing an electronic coupon to the user device.

19. The apparatus of claim 11, wherein wirelessly locating the user device's physical location in the store comprises triangulation using the at least three wireless routers.

20. An apparatus comprising:
a processor for executing computer-executable instructions; and
one or more memories storing the computer-executable instructions that, when executed by the processor, cause the apparatus to perform a method comprising:
connecting a user device to a network located in a store;
wirelessly locating the user device's physical location in the store using a triangulation method with at least three wireless access points;
sending product information to the user device, wherein the product information is based on a product search from the user device, a purchase history, or the user device's physical location in the store and wherein the product information comprises one or more of the following: location information, specifications, reviews, and price comparison;
issuing an electronic coupon to the user device for the product;
providing the user device with an option to purchase the product from the store or online; and
issuing an electronic receipt to the user device if the product is purchased.
